(19) United States
(12) Patent Application Publication
(10) Pub. No.: US 2010/0271186 A1
(43) Pub. Date: Oct. 28, 2010

(54) LOCATION DETERMINATION SYSTEM

(75) Inventors: Hideki TANAKA, Kawasaki (JP); Isamu Yamada, Kawasaki (JP); Shinichi Shiotsu, Kawasaki (JP); Satoshi Inano, Kawasaki (JP); Daisuke Yamashita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/752,277

(22) Filed: Apr. 1, 2010

(30) Foreign Application Priority Data
Apr. 28, 2009 (JP) JP2009-109650

(51) Int. Cl. H04Q 5/22

(52) U.S. Cl. 340/10.3

(57) ABSTRACT

A reader device of a location determination system gradually changes a transmission power step by step and repeatedly sends an interrogation signal which contains therein information on a power level indicating the transmission power. A tag of the location determination system receives the interrogation signal, sends a response signal into which the information on the power level contained in the interrogation signal is incorporated. The reader device receives the response signal and sends, to a management device, the information on the power level contained in the response signal and identification information for identifying the subject reader device. The management device detects the position of the tag based on the information on the power level and the identification information thus received.

### CROSS-REFERENCE TO RELATED APPLICATION

This application is based upon and claims the benefit of priority of the prior Japanese Patent Application No. 2009-109650, filed on Apr. 28, 2009, the entire contents of which are incorporated herein by reference.

### FIELD

The embodiments discussed herein are related to a technology for locating a tag in a Radio Frequency Identification (RFID) system.

### BACKGROUND

Recently, there has been a growing expectation that an RFID technology, i.e., a non-contact identification technology using an Integrated Circuit (IC) chip is used in a variety of different fields represented by inventory management.

An RFID system is typically configured of a tag to be identified, a reader/writer functioning as an identification device, a management device for managing the reader/writer, and so on. The tag includes an IC chip containing data therein and an antenna. The reader/writer serves to read data from the tag and write data thereinto. The management device performs a process on data that has been read out from the tag by the reader/writer.

Suppose that, for example, the RFID technology is used in a distribution industry. Tags are attached to individual items to aid inventory management of the items. Further, tags are attached to individual people, and thereby to know the positions of the individual people in a warehouse.

In short, the position of a tag is detected, which eventually leads to the detection of the position of an item or a person to which the tag is attached.

Incidentally, there has been proposed a technology for detecting the position of a tag. According to the technology, a plurality of reader/writers send signals to a tag with the transmission power reduced gradually. Then, the position of the tag is identified based on response signals sent back from the tag in response to the signals sent by the reader/writers (see Japanese Laid-open Patent Publication Nos. 2001-116583 and 2007-088743).

To be specific, for example, a plurality of reader/writers send signals to a certain tag with the transmission power reduced gradually. There is a correlation between the transmission power level of a signal and the propagation distance of the signal. The correlation therebetween is basically such that the higher the transmission power level is, the longer the propagation distance is. Accordingly, when the transmission power level is high, the propagation distance is long; thereby the tag is capable of receiving signals sent by the reader/writers. Conversely, when the transmission power level is low, the propagation distance is short; thereby the number of signals received by the tag is small.

Suppose that, for example, the number of signals received by the tag is narrowed down to 1 by gradually reducing the transmission power. This means that the tag is closest to a reader/writer, among others, which is the transmission source of the last signal received by the tag.

The technology makes it possible to detect a reader/writer to which the tag is closest among the reader/writers.

### SUMMARY

According to an aspect of the invention (embodiment), a location determination system includes a plurality of reader devices, a management device, and a tag, wherein each of the plurality of reader devices includes an interrogation signal transmission portion that gradually changes a transmission power and sends an interrogation signal containing therein information on a power level indicating the transmission power, and a transmission portion that receives a response signal, and sends, to the management device, information on a power level contained in the response signal and identification information for identifying the subject reader device, the tag includes a response signal transmission portion that receives the interrogation signal and sends a response signal into which the information on the power level contained in the interrogation signal thus received is incorporated, and the management device includes a position detection portion that receives, from the each of the plurality of reader devices, the information on the power level contained in the response signal and the identification information for identifying the subject reader device, and detects a position of the tag based on the information on the power level and the identification information thus received.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of how reader/writers and a tag of a location determination system cooperate with one another;

FIG. 2 is a block diagram illustrating an example of the functional configurations of a reader/writer, a tag, and a management device according to a first embodiment;

FIG. 3 is a diagram illustrating an example of the configuration and details of a propagation distance table;

FIG. 4 is a diagram illustrating an example of the configuration and details of a transmission order table;

FIG. 5 is a diagram illustrating an example of the configuration and details of a responding RW management table;

FIG. 6 is a diagram illustrating an example of the configurations and details of an interrogation signal and a response signal;

FIG. 7 is a timing chart illustrating an example of timing at which communication is performed between reader/writers and a tag;

FIG. 8 is a diagram illustrating an example of coverage of interrogation signals sent by reader/writers at a transmission power level of “0 dBm”;

FIG. 9 is a diagram illustrating an example of coverage of interrogation signals sent by reader/writers at a transmission power level of “−10 dBm”;

FIG. 10 is a diagram illustrating an example of coverage of interrogation signals sent by reader/writers at a transmission power level of “−20 dBm”;

FIG. 11 is a flowchart illustrating an example of the flow of a location determination process for locating a tag performed by a reader/writer, the tag, and a management device according to a first embodiment;

FIG. 12 is a diagram illustrating an example of the configuration and details of a transmission order table for a case where interrogation signals are repeatedly sent with the transmission power level reduced gradually step by step;

FIG. 13 is a diagram illustrating an example of the configuration and details of a transmission order table for a case where interrogation signals are sent with the transmission power level increased gradually step by step;

FIG. 14 is a block diagram illustrating an example of the functional configurations of a reader/writer, a tag, and a management device according to a second embodiment;

FIG. 15 is a diagram illustrating an example of the configuration and details of an interrogation signal management table; and

FIG. 16 is a flowchart illustrating an example of the flow of a location determination process for locating a tag performed by a reader/writer, the tag, and a management device according to a second embodiment.

### DESCRIPTION OF EMBODIMENTS

The conventional technology is used to easily find a reader/writer to which the tag is closest among the reader/writers. Unfortunately, however, the technology needs calculation to determine the distance of the tag from the reader/writer.

Such calculation is performed, for example, in the following manner: The reader/writer detects Received Signal Strength Indication (RSSI) that is a measurement of the power present in a response signal sent by the tag. Then, the distance between the reader/writer and the tag is calculated based on a known correlation between the RSSI and a propagation distance of the response signal.

In such a case, it may be impossible to determine the correct distance between the reader/writer and the tag. This is because noise may affect the determination result, such as that the noise is erroneously determined as the received strength. Further, a certain amount of time is required for the RSSI to be stabilized, and an RSSI measurement circuit is also required.

The object and advantages of the embodiments below will be realized and attained by means of the elements and combinations particularly pointed out in the claims.

### First Embodiment

A plurality of reader/writers send, to a tag, signals repeatedly with the transmission power changed gradually step by step. Such a signal is hereinafter referred to as an “interrogation signal”. The tag that has received the interrogation signals sends back signals to the reader/writers in response to the interrogation signals received. Such a signal sent back to the reader/writer is hereinafter referred to as a “response signal”.

Stated differently, the response signal is to inform the reader/writer of acknowledgement of receipt of the interrogation signal. The reader/writer transmits the response signal, received from the tag, to the management device. In the case where the number of reader/writers that have received a response signal is narrowed down to one, the management device determines that the corresponding reader/writer is a reader/writer closest to the tag among the plurality of reader/writers.

In the first embodiment, a response signal is adapted to acknowledge receipt of an interrogation signal, and also to acknowledge receipt of an interrogation signal which indicates an approximate propagation distance. Stated differently, information indicating acknowledgement of receipt of an interrogation signal and an approximate propagation distance thereof is incorporated into a response signal.

The management device gathers response signals received by the individual reader/writers. The management device is configured to easily determine a distance between each of the reader/writers and a tag merely by referring to information contained in a response signal, which eliminates the need for calculation, and the like.

Specifically, a reader/writer incorporates a power level into an interrogation signal to be sent to a tag, and sends the interrogation signal to the tag. The power level is a value of power at which the interrogation signal is actually sent. The tag that has received the interrogation signal incorporates the power level, which has been contained in the received interrogation signal, into a response signal to be sent in response to the received interrogation signal, and sends the response signal to the reader/writer.

The management device gathers response signals via the reader/writers that have received the response signals from the tag. The management device is capable of finding the following information precisely: Information about which tag has sent each of the response signals; and information about the power level at which the interrogation signal corresponding to each of the response signals has been transmitted.

Stated differently, for example, a table is prepared and stored in advance in which transmission power levels are associated with distances. This enables the determination of the distance between a reader/writer and a tag merely by referring to the table. This eliminates the need for detection of RSSI of a response signal, and for calculation of the distance between a reader/writer and a tag based on the RSSI.

Further, distances to be stored in the table in association with transmission power levels are stored for each reader/writer depending on the characteristics of the reader/writer and the environment for the use thereof. Thereby, the distance between a reader/writer and a tag can be determined precisely. The RFID technology involves using radio waves. If an item to which a tag is attached is metallic, or a tag and the like are used under a high-humidity environment, the communication performance may be affected thereby.

Descriptions are given below of a location determination system according to the first embodiment, with reference to drawings. In the first embodiment, descriptions are provided of an example of a determination as to which tag is present around which reader/writer. It is assumed that a tag described herein is an active tag.

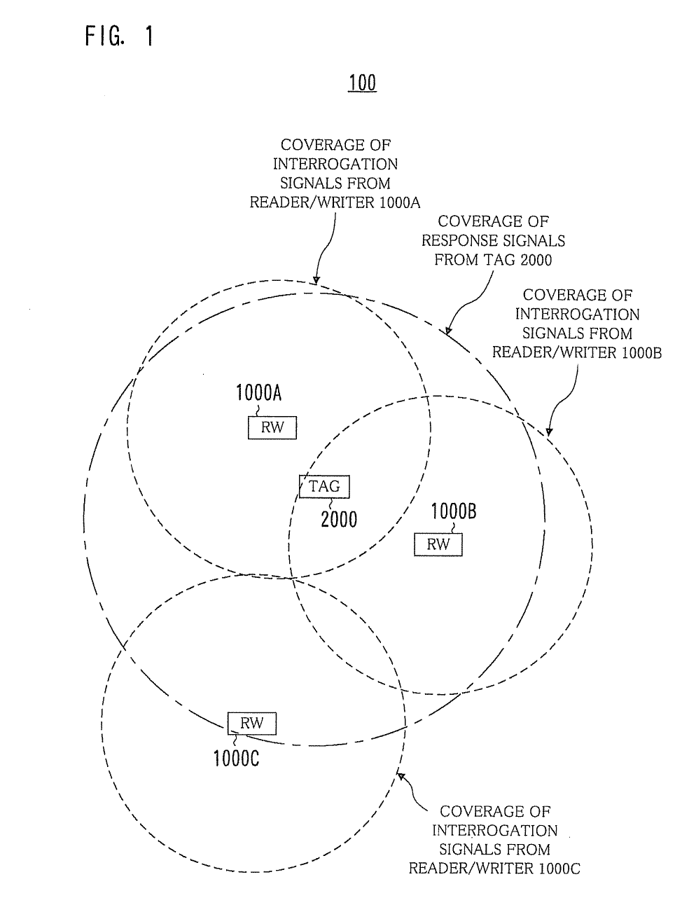

FIG. 1 is a diagram illustrating an example of how reader/writers and a tag of a location determination system 100 of the first embodiment cooperate with one another. FIG. 1 also illustrates an example of coverage of signals sent and received by a tag 2000 and reader/writers 1000A, 1000B, and 1000C included in the location determination system 100. Although only one tag is illustrated in the drawing for simplicity and ease of explanation, a plurality of tags may be included in the location determination system 100.

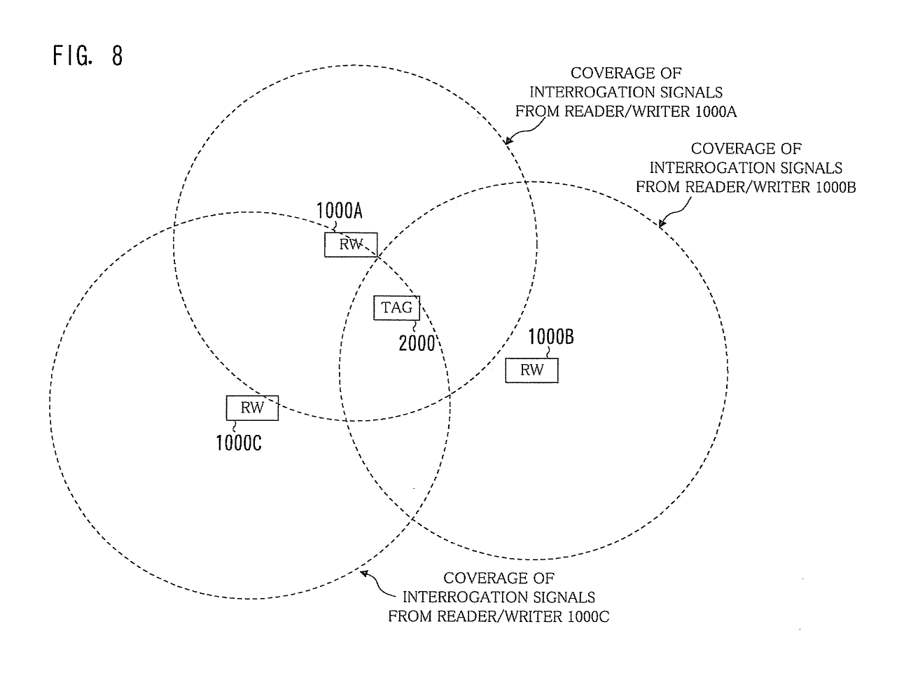

Note that since FIG. 1 is a schematic diagram for description, a ratio between a propagation distance of an interrogation signal and a propagation distance of a response signal, and the like are not accurate. The same applies to, for example, FIG. 8. A reader/writer is denoted by “RW” in FIG. 1. Hereinafter, the reader/writer 1000A, the reader/writer 1000B, and the reader/writer 1000C may be collectively called a “reader/writer 1000”.

Referring to FIG. 1, the area of a circle represents signal coverage. To be specific, the area of a dotted circle represents coverage of an interrogation signal sent by the reader/writer 1000. The area of a dot-dashed circle represents coverage of a response signal sent by the tag 2000.

In the illustrated example, the tag 2000 is present within coverage of an interrogation signal sent by the reader/writer 1000A, and also within coverage of an interrogation signal sent by the reader/writer 1000B. The tag 2000, thus, receives interrogation signals sent by the reader/writers 1000A and 1000B.

The tag 2000 sends a response signal in response to each of the received interrogation signals. The response signal sent from the tag 2000 is received by all the reader/writers within the coverage of the response signal. In the case of FIG. 1, the reader/writer 1000A, the reader/writer 1000B, and the reader/writer 1000C are supposed to receive the response signal from the tag 2000.

Referring to FIG. 1, the reader/writer 1000C is supposed to receive response signals directed from the tag 2000 to the reader/writer 1000A and the reader/writer 1000B. Such response signals, however, are not response signals corresponding to interrogation signals sent by the reader/writer 1000C; therefore the reader/writer 1000C discards the response signals. Likewise, the reader/writer 1000A discards, among response signals received thereby, response signals other than response signals corresponding to interrogation signals sent by the reader/writer 1000A itself. The same applies to the case of the reader/writer 1000B.

A response signal contains therein an ID of a reader/writer in order to indicate a reader/writer that has sent the interrogation signal corresponding to the response signal. Thus, if the reader/writer 1000 receives a response signal, and the response signal does not contain the ID of the subject reader/writer 1000, then the reader/writer 1000 discards the received response signal.

The reader/writer 1000 incorporates the ID of the subject reader/writer 1000 into an interrogation signal, and sends the interrogation signal to the tag 2000. The tag 2000 incorporates the ID of the reader/writer 1000, which is contained in the interrogation signal that the tag 2000 has received, into a response signal, and sends the response signal to the reader/writer 1000. In this way, the response signal indicates which reader/writer has sent the interrogation signal corresponding to the subject response signal.

Hereinafter, the wording to the effect that “a response signal is received” is assumed to mean that a reader/writer receives a response signal directed to the subject reader/writer.

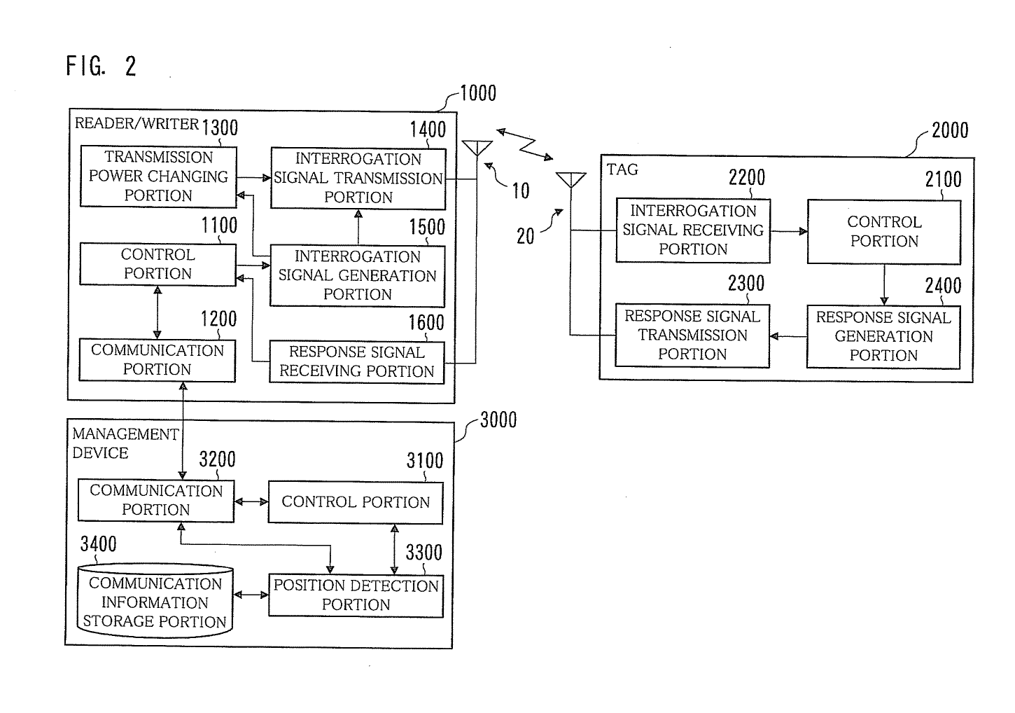

Referring now to FIG. 2, descriptions are given of the reader/writer 1000, the tag 2000, and the management device 3000, all of which are included in the location determination system 100 of the first embodiment.

FIG. 2 is a block diagram illustrating an example of the functional configurations of the reader/writer 1000, the tag 2000, and the management device 3000.

The reader/writer 1000 is configured of a control portion 1100, a communication portion 1200, a transmission power changing portion 1300, an interrogation signal transmission portion 1400, an interrogation signal generation portion 1500, a response signal receiving portion 1600, an antenna 10, and the like.

The control portion 1100 controls processes necessary for a typical reader/writer, and processes unique to the present embodiment such as a process for sending an interrogation signal containing a transmission power level therein.

The communication portion 1200 serves to perform communication with the management device 3000.

The transmission power changing portion 1300 controls a transmission power level for transmission of an interrogation signal by the interrogation signal transmission portion 1400 to become a given value.

The interrogation signal transmission portion 1400 serves to send, via the antenna 10, an interrogation signal conveyed by the interrogation signal generation portion 1500. The interrogation signal transmission portion 1400 changes a transmission power level for transmission of an interrogation signal based on the control performed by the transmission power changing portion 1300, and adjusts a value of radio wave outputted from the antenna 10.

The interrogation signal generation portion 1500 serves to generate an interrogation signal in accordance with a request from the control portion 1100. In the generation of the interrogation signal, the interrogation signal generation portion 1500 incorporates, into the interrogation signal, a command indicating a process to be performed by a tag, and data necessary for the process. In the case where, for example, the tag is requested to perform a process for locating the tag itself, the interrogation signal generation portion 1500 incorporates the command indicating the request, and a transmission power level into the interrogation signal.

The response signal receiving portion 1600 receives a response signal from the tag 2000 via the antenna 10, analyzes the response signal received, and conveys necessary information to the control portion 1100.

In the meanwhile, the tag 2000 is configured of a control portion 2100, an interrogation signal receiving portion 2200, a response signal transmission portion 2300, a response signal generation portion 2400, an antenna 20, and the like.

The control portion 2100 controls processes necessary for a typical tag. The control portion 2100 also controls a process for analyzing a command contained in an interrogation signal received from the reader/writer 1000, and a process based on the command.

The interrogation signal receiving portion 2200 receives an interrogation signal from the reader/writer 1000 via the antenna 20, and conveys, to the control portion 2100, necessary information contained in the received interrogation signal.

The response signal transmission portion 2300 transmits a response signal, conveyed by the response signal generation portion 2400, to the reader/writer 1000 via the antenna 20.

The response signal generation portion 2400 serves to generate a response signal in response to a request from the control portion 2100. The response signal generation portion 2400 generates a response signal into which a power level is incorporated in accordance with a request from the control portion 2100.

In the meanwhile, the management device 3000 is a so-called server, and is a device having a function of receiving data from the reader/writer 1000 to perform a given process, a function of requesting the reader/writer 1000 to perform a process, and other functions.

The management device 3000 is configured of a control portion 3100, a communication portion 3200, a position detection portion 3300, a communication information storage portion 3400, and the like.

The control portion 3100 controls processes necessary for a typical server, and processes unique to the present embodiment. For example, upon receiving a command, given by a user, to start a process for locating a tag, the control portion 3100 instructs the individual reader/writers to transmit a location determination command.

The communication portion 3200 serves to perform communication with the reader/writer 1000.

Upon receiving a request from the control portion 3100, the position detection portion 3300 performs a process for detecting the position of the tag 2000. Hereinafter, such a process is referred to as a “location determination process”. To be specific, a command to send an interrogation signal for location determination is transmitted to the reader/writer 1000. The position detection portion 3300 also receives, from the reader/writer 1000, data on a response signal received by the reader/writer 1000, analyzes the data received, and detects the position of the tag 2000. A method for detecting the position of the tag 2000 will be described below in the [LOCATION DETERMINATION METHOD] section.

The communication information storage portion 3400 has a function to store, therein, information on a transmission power level that the reader/writer 1000 is to incorporate into an interrogation signal, and a propagation distance of the interrogation signal in accordance with the transmission power level.

The individual CPUs included in the reader/writer 1000, the tag 2000, and the management device 3000 execute programs stored in memories thereof; thereby a part or the whole of the functions discussed above are implemented.

[Data]

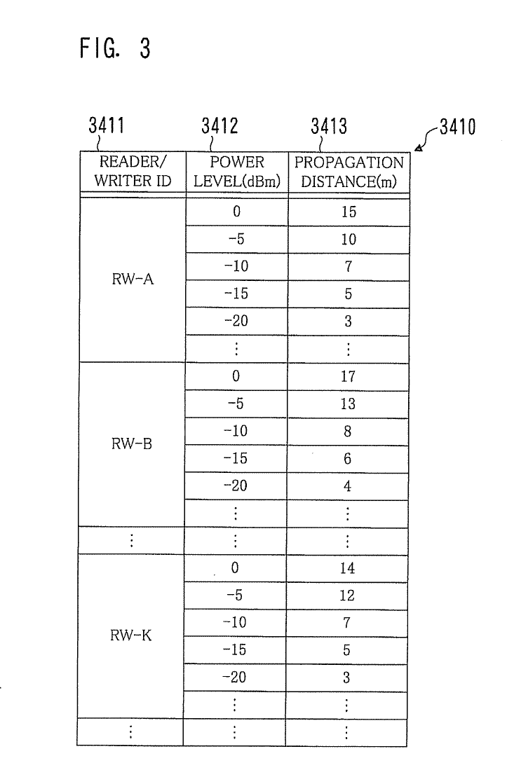

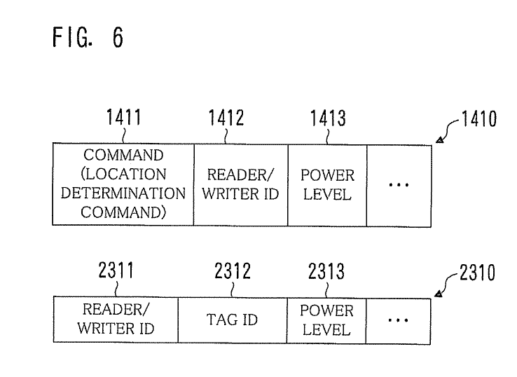

The following is a description of data used in the location determination system 100 of the first embodiment, with reference to FIGS. 3-6. Data described with reference to FIGS. 3-5 is data stored in the communication information storage portion 3400 of the management device 3000, and is created in advance by an administrator and the like of the location determination system 100. Further, data described with reference to FIG. 6 is data communicated between the reader/writer 1000 and the tag 2000, that is, an interrogation signal and a response signal communicated therebetween.

FIG. 3 is a diagram illustrating an example of the configuration and details of a propagation distance table 3410.

The propagation distance table 3410 stores, therein, information on all the reader/writers managed by the management device 3000.

The propagation distance table 3410 includes the fields of “reader/writer ID” 3411, “power level” 3412, and “propagation distance” 3413.

The reader/writer ID field 3411 indicates an identifier (ID) for identifying the corresponding reader/writer 1000.

The power level field 3412 indicates a value of transmission power at which an interrogation signal is sent.

The propagation distance field 3413 indicates a propagation distance of an interrogation signal for a case in which the reader/writer 1000 corresponding to an ID specified in the reader/writer ID field 3411 transmits the interrogation signal at a transmission power level specified in the power level field 3412.

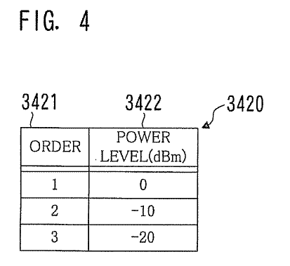

FIG. 4 is a diagram illustrating an example of the configuration and details of a transmission order table 3420. The transmission order table 3420 defines the transmission order and transmission power levels of interrogation signals based on which the reader/writer 1000 is caused to send interrogation signals.

The transmission order table 3420 includes the fields of “order” 3421 and “power level” 3422.

The order field 3421 indicates a transmission order based on which the reader/writer 1000 is instructed to send interrogation signals.

The power level field 3422 indicates power levels that the reader/writer 1000 is to incorporate into individual interrogation signals.

In principle, the reader/writer 1000 repeatedly transmits interrogation signals whose quantity corresponds to the number of records registered in the transmission order table 3420. Specifically, the reader/writer 1000 transmits interrogation signals sequentially starting with an interrogation signal corresponding to the record having the value “1” in the order field 3421 at the corresponding transmission power level specified in the power level field 3422.

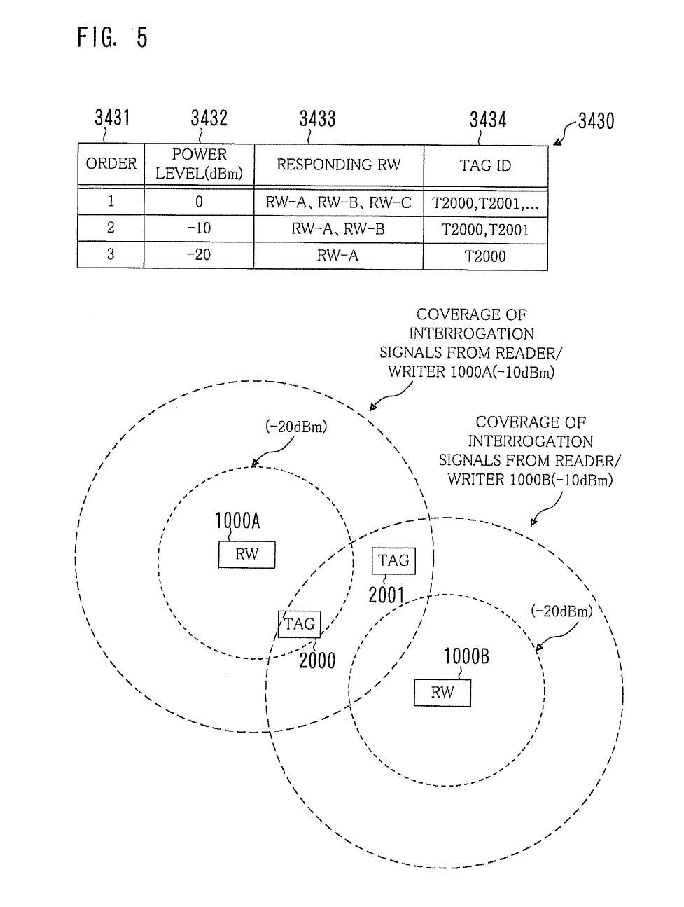

FIG. 5 is a diagram illustrating an example of the configuration and details of a responding RW management table 3430. The responding RW management table 3430 is a table for managing reader/writers that have received a response signal from a tag. The responding RW management table 3430 is used during the location determination process.

The lower diagram of FIG. 5 illustrates the tag 2000, a tag 2001, and individual propagation distances of interrogation signals transmitted by the reader/writer 1000A and the reader/writer 1000B.

The responding RW management table 3430 includes the fields of “order” 3431, “power level” 3432, “responding RW” 3433, and “tag ID” 3434.

The order field 3431 indicates the order based on which the reader/writer 1000 has been instructed to send interrogation signals. The order specified in the order field 3431 is the same as that specified in the order field 3421 of the transmission order table 3420. Referring to FIG. 4, suppose that, for example, the reader/writer 1000 is caused to send an interrogation signal at a power level specified in the power level field 3422 of a record corresponding to the value “1” specified in the order field 3421 of the transmission order table 3420. Referring now to FIG. 5, the result is registered as a record corresponding to the value “1” specified in the order field 3431 of the responding RW management table 3430.

The power level field 3432 indicates a power level that the reader/writer 1000 has incorporated into the interrogation signal and sent the same to a tag.

The responding RW field 3433 indicates an ID, among the reader/writers that have sent interrogation signals at power levels specified in the power level field 3432, an ID of a reader/writer that has received a response signal from a tag.

The tag ID field 3434 indicates an ID of a tag that has transmitted a response signal received by the reader/writer indicated in the responding RW field 3433.

FIG. 6 is a diagram illustrating an example of the configurations and details of an interrogation signal 1410 and a response signal 2310. The interrogation signal 1410 is a signal transmitted by the reader/writer 1000, while the response signal 2310 is a signal transmitted by the tag 2000.

The interrogation signal 1410 contains, therein, a command 1411, a reader/writer ID 1412, and a power level 1413.

The command 1411 indicates the details of a process to be requested to the tag 2000 that is supposed to receive the subject interrogation signal 1410. In the first embodiment, the command 1411 indicates a code of a “location determination command” for requesting the tag 2000 to detect the position of the tag 2000.

The reader/writer ID 1412 intends the reader/writer 1000 that is the transmission source of the subject interrogation signal 1410. To be specific, the reader/writer ID 1412 indicates an ID for identifying the reader/writer 1000 that has transmitted the subject interrogation signal 1410.

The power level 1413 indicates a transmission power level for a case in which the subject interrogation signal 1410 is transmitted. A value indicated in the power level 1413 is effective only when a code of a location determination command is set in the command 1411.

The reader/writer 1000 transmits the interrogation signal 1410 at a transmission power level specified in the power level 1413.

The response signal 2310 contains, therein, a reader/writer ID 2311, a tag ID 2312, and a power level 2313.

The reader/writer ID 2311 intends the reader/writer 1000 that is the destination of the subject response signal 2310. This is because the response signal 2310 is to be transmitted, in response to an interrogation signal 1410 received by the tag, to the reader/writer 1000 that is the transmission source of the interrogation signal 1410 received. To be specific, the reader/writer ID 2311 indicates an ID of the reader/writer which has been set as the reader/writer ID 1412 of the received interrogation signal 1410.

The tag ID 2312 intends a tag sending the subject response signal 2310. Specifically, the tag ID 2312 indicates an ID of such a tag.

The power level 2313 indicates an output power level of the interrogation signal 1410 received by the tag identified by the tag ID 2312. Specifically, a value that has been set as the power level 1413 of the received interrogation signal 1410 is directly set in the power level 2313.

[Location Determination Method]

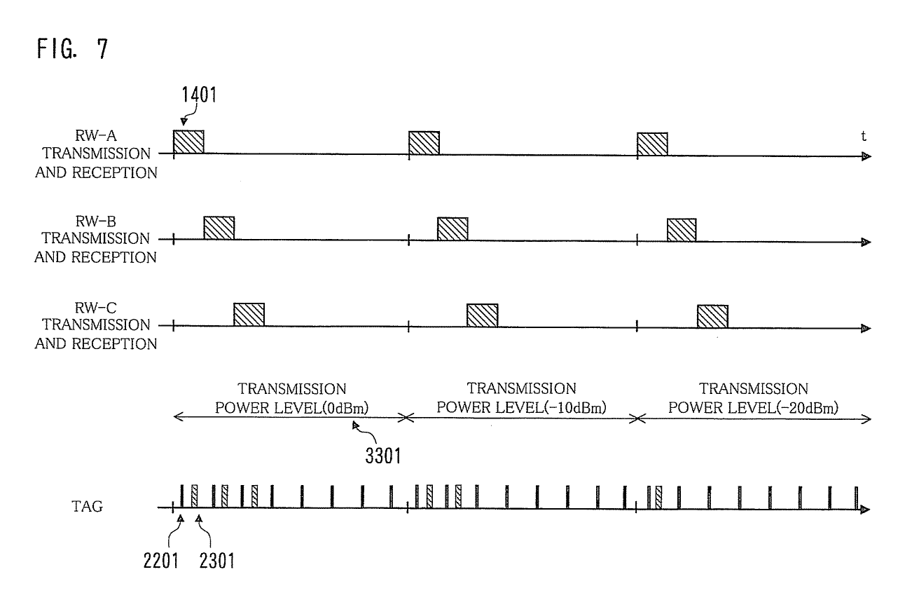

The following is a description of an example in which the position of a tag is determined in the location determination system 100, with reference to FIGS. 7-10.

FIG. 7 is a timing chart illustrating an example of timing at which communication is performed between the reader/writer 1000 and the tag 2000. Referring to FIG. 7, the reader/writer 1000 is denoted by using a reader/writer ID. For example, the reader/writer 1000A, the reader/writer 1000B, and the reader/writer 1000C are denoted by “RW-A”, “RW-B”, and “RW-C”, respectively. A rectangle on the upper side of the time axis for each of the reader/writers represents a transmission and reception period 1401 assigned to each of the reader/writers. The reader/writer 1000 transmits an interrogation signal 1410 and receives a response signal 2310 during the transmission and reception period 1401 assigned thereto.

Referring to the lowest part of FIG. 7, individual vertical short lines in the time axis for the tag 2000 represent a reception timing 2201 of an interrogation signal 1410 and a transmission timing 2301 of a response signal 2310.

As evident from FIG. 7, the individual reader/writers transmit interrogation signals 1410 in such a manner to avoid the overlap of the transmission and reception periods 1401 thereof with one another.

The tag 2000 attempts to receive an interrogation signal 1410 at the reception timing 2201. If receiving the interrogation signal 1410 at the reception timing 2201, then the tag 2000 transmits a response signal 2310 at the transmission timing 2301.

In the first embodiment, the reader/writer 1000 transmits an interrogation signal 1410 at a transmission power level illustrated between the timing chart of the reader/writer 1000 and the timing chart of the tag 2000.

It is assumed that the order of the reader/writers transmitting interrogation signals 1410 is determined in advance. The management device 3000 appropriately gives commands to the individual reader/writers in accordance with the order determined in advance. Upon receiving such a command from the management device 3000, each of the reader/writers transmits an interrogation signal 1410.

The management device 3000 changes the transmission power level after a given amount of time 3301 has elapsed since the transmission of an interrogation signal 1410 at a certain transmission power level was started, and causes the reader/writer 1000 to transmit interrogation signals 1410 in the order determined in advance.

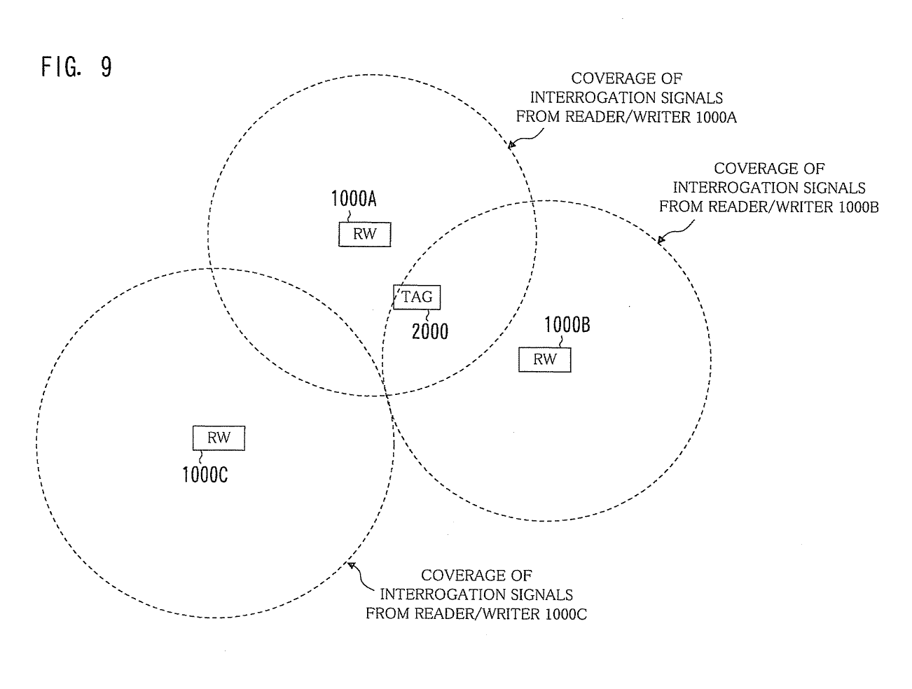

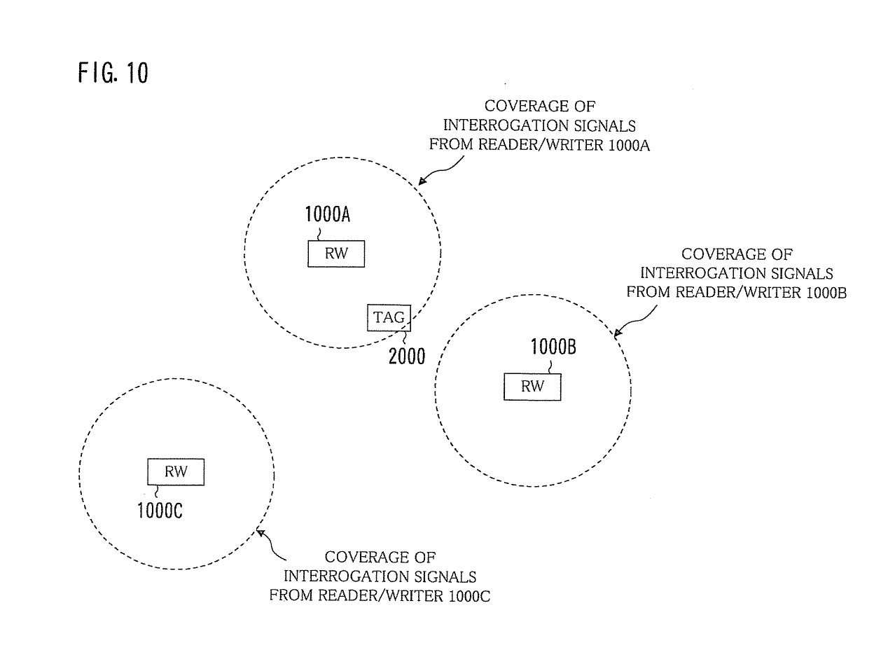

FIG. 8 is a diagram illustrating an example of coverage of interrogation signals 1410 sent by the individual reader/writers at a transmission power level of “0 dBm”. FIG. 9 is a diagram illustrating an example of coverage of interrogation signals 1410 sent by the individual reader/writers at a transmission power level of “−10 dBm”. FIG. 10 is a diagram illustrating an example of coverage of interrogation signals 1410 sent by the individual reader/writers 1000 at a transmission power level of “−20 dBm”.

In this way, the transmission power level is gradually reduced step by step; thereby the coverage of the interrogation signal 1410 is also gradually reduced step by step.

Referring to FIG. 8, the tag 2000 is present within the coverage of interrogation signals 1410 transmitted by the reader/writer 1000A, the reader/writer 1000B, and the reader/writer 1000C. Referring to FIG. 9, the tag 2000 is present within the coverage of interrogation signals 1410 transmitted by the reader/writer 1000A and the reader/writer 1000B. Referring then to FIG. 10, the tag 2000 is present only within the coverage of an interrogation signal 1410 transmitted by the reader/writer 1000A.

Thus, in the illustrated example of FIG. 8, the reader/writer 1000 receiving a response signal 2310 from the tag 2000 is three reader/writers, i.e., the reader/writer 1000A, the reader/writer 1000B, and the reader/writer 1000C. As for FIG. 9, two reader/writers, i.e., the reader/writer 1000A and the reader/writer 1000B receive a response signal 2310 from the tag 2000. As for FIG. 10, only the reader/writer 1000A receives a response signal 2310 from the tag 2000.

This example illustrated in FIG. 8, FIG. 9 and FIG. 10 demonstrates that the position of the tag 2000 is closest to the reader/writer 1000A. This example also demonstrates that the tag 2000 is present within the propagation distance of an interrogation signal 1410 that is transmitted at a transmission power level of “−20 dBm” by the reader/writer 1000A.

In the first embodiment, the response signal 2310 received by the reader/writer 1000A, which is left as the last reader/writer that receives the interrogation signal 1410 from the tag 2000, contains the power level 2313 at which the reader/writer 1000A has transmitted interrogation signals 1410. Accordingly, the propagation distance table 3410 is referred to based on the power level 2313 contained in the response signal 2310 received by the reader/writer 1000A. Thereby, the distance between the reader/writer 1000A and the tag 2000 is easily detected.

Note that the positions of the individual reader/writers such as the longitude and the latitude thereof are measured in advance and stored in the management device 3000.

[Operation]

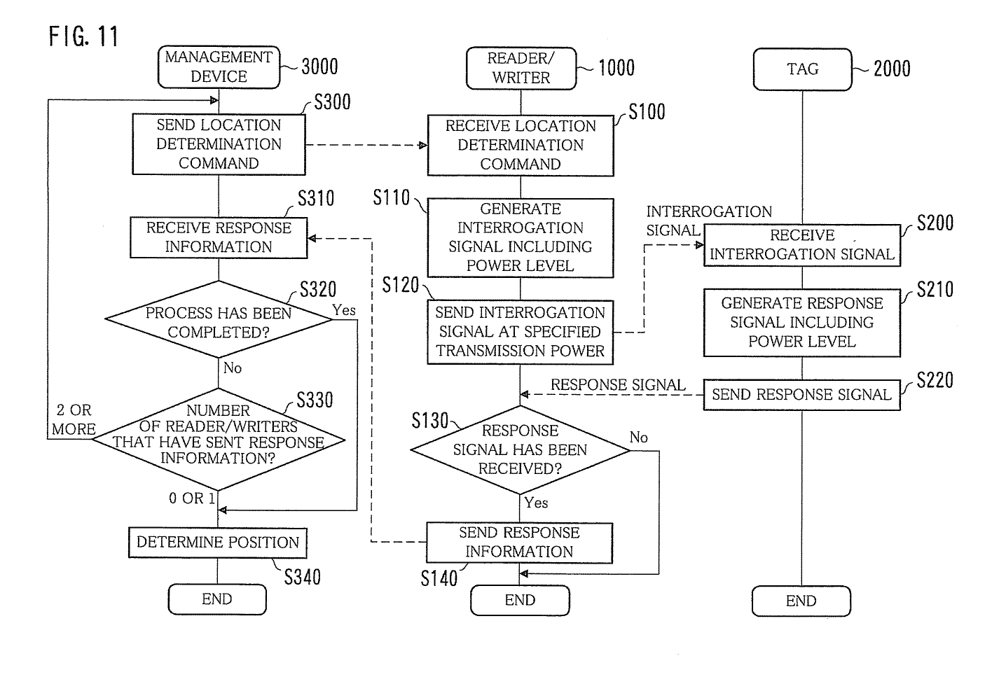

The following is a description of operation performed in the location determination system 100 of the first embodiment, with reference to FIG. 11.

FIG. 11 is a flowchart illustrating an example of the flow of a location determination process for locating the tag 2000 performed by the reader/writer 1000, the tag 2000, and the management device 3000.

Upon receiving a command, given by a user, to start a location determination process, the control portion 3100 of the management device 3000 instructs the position detection portion 3300 to detect the position of the tag 2000.

Responding to the receipt of the instruction from the control portion 3100, the position detection portion 3300 transmits a command (location determination command) to determine the location of the tag 2000 to each of the reader/writers via the communication portion 3200 (Step S300).

In the transmission of the location determination command, the position detection portion 3300 reads out, from the transmission order table 3420 (see FIG. 4) stored in the communication information storage portion 3400, a value specified in the power level field 3422 of a record corresponding to the value “1” in the order field 3421, and transmits the value read out to the individual reader/writers.

In this instance, the position detection portion 3300 may transmit the location determination commands to the individual reader/writers depending on the order based on which the individual reader/writers are caused to send interrogation signals 1410. In the illustrated example of FIG. 7, since the reader/writer 1000A is supposed to send an interrogation signal 1410 first, the position detection portion 3300 transmits the location determination command, first, to the reader/writer 1000A. Since the reader/writer 1000B is supposed to send an interrogation signal 1410 second, the position detection portion 3300 waits for the transmission and reception period 1401 to elapse, and transmits the location determination command to the reader/writer 1000B.

At a time when the position detection portion 3300 gives the location determination command to the reader/writer that is supposed to send an interrogation signal 1410 first, the position detection portion 3300 starts measuring the given amount of time 3301 (see FIG. 7). In the illustrated example of FIG. 7, at a time when the position detection portion 3300 gives the location determination command to the reader/writer 1000A with “0 dBm” set as the transmission power level, the position detection portion 3300 starts the measurement.

Upon receiving the location determination command and the power level (Step S100), the communication portion 1200 of the reader/writer 1000 conveys, to the control portion 1100, the fact that the location determination command has been received, and the received power level.

The control portion 1100 conveys, to the interrogation signal generation portion 1500, the power level received from the communication portion 1200, and requests the interrogation signal generation portion 1500 to generate an interrogation signal containing therein a location determination command and transmit the generated interrogation signal.

Upon receiving the request from the control portion 1100, the interrogation signal generation portion 1500 generates an interrogation signal (see FIG. 6) (Step S110).

To be specific, the interrogation signal generation portion 1500 sets, as the command 1411, a code indicating a location determination command, as the reader/writer ID 1412, an ID of the subject reader/writer 1000, and, as the power level 1413, the power level conveyed by the control portion 1100.

Subsequently, the interrogation signal generation portion 1500 sends the power level conveyed by the control portion 1100 to the transmission power changing portion 1300, and requests the transmission power changing portion 1300 to change the level of the transmission power.

The transmission power changing portion 1300 controls the transmission power for a case in which the interrogation signal transmission portion 1400 transmits the interrogation signal 1410 to have the power level conveyed by the interrogation signal generation portion 1500.

After sending the request to change the level of the transmission power, the interrogation signal generation portion 1500 conveys the generated interrogation signal 1410 to the interrogation signal transmission portion 1400, and requests the same to send the interrogation signal 1410.

In accordance with the request, the interrogation signal transmission portion 1400 transmits, via the antenna 10, to the tag 2000, the interrogation signal 1410 received from the interrogation signal generation portion 1500 (Step S120).

The interrogation signal receiving portion 2200 of the tag 2000 receives the interrogation signal 1410 via the antenna 20 (Step S200). The interrogation signal receiving portion 2200, then, analyzes the interrogation signal 1410 received and conveys, to the control portion 2100, information indicating that the interrogation signal 1410 contains a location determination command, the reader/writer ID set as the reader/writer ID 1412, and the power level set as the power level 1413.

The control portion 2100 that has received the information requests the response signal generation portion 2400 to generate a response signal 2310 in accordance with the location determination command and transmit the response signal 2310. In the transmission of the request for generating a response signal 2310, the control portion 2100 sends, to the response signal generation portion 2400, the reader/writer ID and the power level both of which are received from the interrogation signal receiving portion 2200.

Responding to the receipt of the request from the control portion 2100, the response signal generation portion 2400 generates a response signal 2310 (see FIG. 6) (Step S210).

To be specific, the response signal generation portion 2400 sets, as the reader/writer ID 2311 of the response signal 2310, the reader/writer ID sent by the control portion 2100. The response signal generation portion 2400 also sets, as the tag ID 2312, an ID of the subject tag 2000. The response signal generation portion 2400 further sets, as the power level 2313, the power level received from the control portion 2100.

Subsequently, the response signal generation portion 2400 conveys the response signal 2310 generated to the response signal transmission portion 2300, and requests the same to transmit the response signal 2310.

Upon receiving the request, the response signal transmission portion 2300 transmits, via the antenna 20, the response signal 2310 to the reader/writer 1000 (Step S220).

The response signal receiving portion 1600 of the reader/writer 1000 receives the response signal 2310 via the antenna 10 (Step S130: YES). The response signal receiving portion 1600 then analyzes the response signal 2310 received, and conveys, to the control portion 1100, the ID of the tag set as the tag ID 2312 of the response signal 2310, and the power level set as the power level 2313 thereof.

The control portion 1100 transmits via the communication portion 1200 to the management device 3000 the tag ID, the power level, both of which are conveyed by the response signal receiving portion 1600, and the subject device ID for identifying the subject reader/writer 1000 (Step S140).

On the other hand, unless the reader/writer 1000 receives a response signal 2310 from the tag 2000 (Step S130: NO), nothing is transmitted to the management device 3000.

The communication portion 3200 of the management device 3000 receives the tag ID, the power level, and the subject device ID from the reader/writer 1000 (Step S310). The communication portion 3200 then conveys the tag ID, the power level, and the subject device ID thus received to the position detection portion 3300.

Responding to the receipt of the tag ID, the power level, and the subject device ID, the position detection portion 3300 registers the tag ID, the power level, and the subject device ID into the responding RW management table 3430.

To be specific, the position detection portion 3300 registers the subject device ID and the tag ID, which are received from the communication portion 3200, respectively in the responding RW field 3433 and the tag ID field 3434 of a record having the same value in the power level field 3432 as the power level received from the communication portion 3200.

If the processes have already been performed on the last record of the transmission order table 3420 in FIG. 4, e.g., the record having a value of “3” in the order field 3421 thereof (Step S320: YES), then the position detection portion 3300 determines the position of a tag (Step S340).

If there remains a record to be processed in the transmission order table 3420 (Step S320: NO), then the position detection portion 3300 determines whether or not the given amount of time 3301 (see FIG. 7) has elapsed.

If determining that the given amount of time 3301 has elapsed, then the position detection portion 3300 calculates the number of IDs of the reader/writer 1000 that are registered in the responding RW field 3433 of the responding RW management table 3430.

If the number obtained by the calculation is two or more (Step S330: 2 or more), then the position detection portion 3300 conveys, via the communication portion 3200, to the individual reader/writers, a value specified in the power level field 3422 of a record corresponding to the next order in the order field 3421 of the transmission order table 3420, e.g., a record having the value “2” specified therein. The position detection portion 3300 also transmits location determination commands to the individual reader/writers via the communication portion 3200, and repeats the process of Step S300 through Step S310.

If the number obtained by the calculation is zero or one (Step S330: 0 or 1), then the position detection portion 3300 determines the position of a tag (Step S340).

To be specific, if the responding RW management table 3430 has a record (called a target record below) having a single reader/writer in the responding RW field 3433, then the position detection portion 3300 refers to the propagation distance table 3410 (see FIG. 3), and determines the distance from the single reader/writer specified in the responding RW field 3433 to the tag 2000.

To be more specific, a candidate record is found out in the propagation distance table 3410. The candidate record is a record having the same reader/writer ID as that specified in the responding RW field 3433 of the target record in the responding RW management table 3430, and at the same time, having the same power level as that specified in the power level field 3432 of the target record in the responding RW management table 3430. The position detection portion 3300 then reads out, from the propagation distance table 3410, a value specified in the propagation distance field 3413 of the candidate record thus found out. The value that has been read out is determined to be the distance from the tag identified by the tag ID registered in the tag ID field 3434 of the target record in the responding RW management table 3430.

In the illustrated example of FIG. 5, only “RW-A” is registered in the responding RW field 3433 of a record having the value “3” in the order field 3431 of the responding RW management able 3430. Referring now to the propagation distance table 3410, the value “3” is indicated in the propagation distance field 3413 corresponding to the record having “RW-A” in the reader/writer ID field 3411 and having “−20” in the power level field 3412. Thus, the position detection portion 3300 detects that the position of the tag 2000 identified by “T2000” specified in the tag ID field 3434 is “3” meters or less away from the reader/writer 1000 identified by “RW-A”.

Referring to FIG. 5, a record having the value “2” in the order field 3431 has “RW-A, RW-B” in the responding RW field 3433. The example of the record having the value “2” demonstrates that the tag 2000 is closer to the reader/writer 1000A than to the reader/writer 1000B (see the tag 2000 in the lower diagram of FIG. 5).

It is assumed that, in the responding RW management table 3430 of FIG. 5, a record having the value “3” in the order field 3431 has no reader/writer IDs registered in the responding RW field 3433. The example of the record having the value “3” demonstrates that the number of reader/writers is zero in Step S330.

This means that there are no records having a single reader/writer registered in the responding RW field 3433. In such a case, the position detection portion 3300 detects the position of the tag 2000 based on reader/writer IDs for a record having the previous order in the order field 3431, i.e., based on “RW-A” and “RW-B” registered in the responding RW field 3433 for a record having the value “2” in the order field 3431. The position detection portion 3300 detects that the positions of the tag 2000 and the tag 2001 denoted respectively by “T2000” and “T2001” registered in the tag ID field 3434 fall within an area where coverage of interrogation signals transmitted by the reader/writer 1000A and coverage of interrogation signals transmitted by the reader/writer 1000B overlap with each other.

[First Modification]

In the first embodiment, as illustrated in the transmission order table 3420 of FIG. 4, interrogation signals 1410 are sent with the transmission power level gradually reduced step by step.

Another configuration is possible, as the first modification, in which a process of transmitting interrogation signals 1410 with the transmission power level gradually reduced step by step is performed, and the process is repeated.

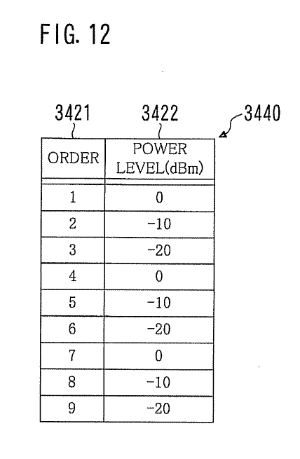

An example of the configuration and details of a transmission order table 3440 according to the first modification is illustrated in FIG. 12.

The transmission order table 3440 includes the fields of “order” 3421 and “power level” 3422.

The order field 3421 indicates a transmission order based on which the reader/writer 1000 is instructed to send interrogation signals. The power level field 3422 indicates power levels that the reader/writer 1000 is to incorporate into individual interrogation signals.

As discussed in the first modification, the repeated transmissions of the interrogation signals 1410 provide a high probability of reception of the interrogation signals 1410, for example, even when the reception an interrogation signal 1410 sent first fails for some reason although a tag is present within the coverage of the interrogation signals 1410. In short, the repeated transmission of the interrogation signals 1410 makes it possible to detect the position of a tag with high probability.

[Second Modification]

Yet another configuration is possible, as the second modification, in which a process of transmission of interrogation signals 1410 with the transmission power level gradually increased step by step is performed.

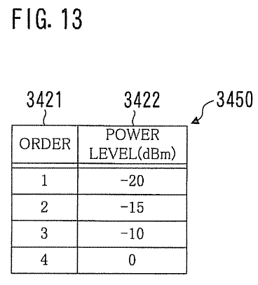

An example of the configuration and details of a transmission order table 3450 according to the second modification is illustrated in FIG. 13.

The transmission order table 3450 includes the fields of “order” 3421 and “power level” 3422.

The order field 3421 indicates a transmission order based on which the reader/writer 1000 is instructed to send interrogation signals. The power level field 3422 indicates power levels that the reader/writer 1000 is to incorporate into individual interrogation signals.

As discussed in the second modification, expanding the coverage of interrogation signals provides an advantage in that a tag can be found out early when the tag is present around a reader/writer.

### Second Embodiment

In the first embodiment, the management device 3000 gathers, from the reader/writer 1000, information on response signals 2310 received by the reader/writer 1000, and detects the position of a tag based on the information gathered.

According to the second embodiment, a tag 4000 itself detects a reader/writer that is closest thereto among a plurality of reader/writers, incorporates an ID of the detected reader/writer into a response signal 2310, and transmits the response signal 2310.

A location determination system 100 according to the second embodiment will be described below, focusing on the differences between the first embodiment and the second embodiment.

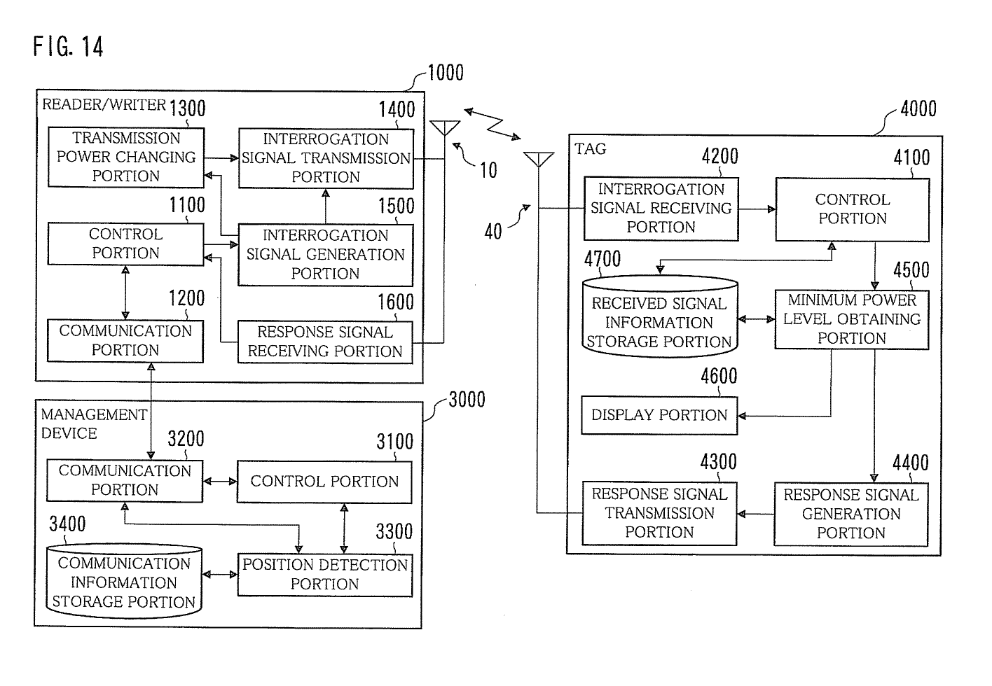

Referring now to FIG. 14, descriptions are given below of the reader/writer 1000, a tag 4000, and the management device 3000, all of which are included in the location determination system 100 of the second embodiment.

FIG. 14 is a block diagram illustrating an example of the functional configurations of the reader/writer 1000, the tag 4000, and the management device 3000.

The reader/writer 1000 and the management device 3000 in FIG. 14 are respectively the same as the reader/writer 1000 and the management device 3000 of the first embodiment described earlier with reference to FIG. 2.

Descriptions are provided of the tag 4000, focusing on the differences from the tag 2000 of the first embodiment.

The tag 4000 is configured of a control portion 4100, an interrogation signal receiving portion 4200, a response signal transmission portion 4300, a response signal generation portion 4400, a minimum power level obtaining portion 4500, a display portion 4600, a received signal information storage portion 4700, an antenna 40, and the like.

The control portion 4100, the interrogation signal receiving portion 4200, the response signal transmission portion 4300, the response signal generation portion 4400, and the antenna 40 respectively have the same functions as the control portion 2100, the interrogation signal receiving portion 2200, the response signal transmission portion 2300, the response signal generation portion 2400, and the antenna 20 of the tag 2000 in the first embodiment.

The minimum power level obtaining portion 4500 serves to determine, in accordance with a request from the control portion 4100, the lowest power level among power levels contained in interrogation signals 1410 received by the tag 4000, and determine the reader/writer 1000 that has transmitted an interrogation signal 1410 containing the lowest power level therein. To be specific, the minimum power level obtaining portion 4500 refers to data stored in the received signal information storage portion 4700.

The display portion 4600 is configured of a liquid-crystal display, and operable to display, on the liquid-crystal display, information on the reader/writer 1000 received from the minimum power level obtaining portion 4500.

The configuration of the display portion 4600 enables a user carrying the tag 4000 to find a reader/writer closest to the tag 4000 among others.

The received signal information storage portion 4700 serves to store, therein, information on interrogation signals received by the tag 4000.

The individual CPUs included in the reader/writer 1000, the tag 4000, and the management device 3000 execute programs stored in memories thereof; thereby a part or the whole of the functions discussed above are implemented.

[DATA]

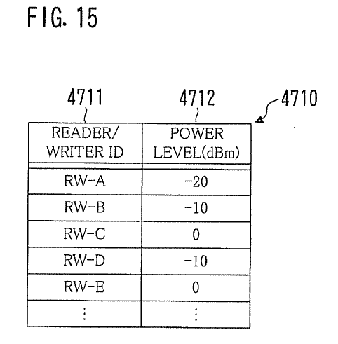

The following is a description of the main data used in the location determination system 100 of the second embodiment, with reference to FIG. 15. Among the data used in the location determination system 100 of the first embodiment, the data described earlier with reference to FIGS. 3, 4, and 6 is also used in the location determination system 100 of the second embodiment.

FIG. 15 is a diagram illustrating an example of the configuration and details of an interrogation signal management table 4710.

The interrogation signal management table 4710 is stored in the received signal information storage portion 4700 of the tag 4000. Every time when an interrogation signal 1410 (see FIG. 6) is received, information on the interrogation signal 1410 received is registered in the interrogation signal management table 4710. When a location determination process for locating a tag is completed, the information registered in the interrogation signal management table 4710 is deleted.

The interrogation signal management table 4710 includes the fields of “reader/writer ID” 4711 and “power level” 4712.

The reader/writer ID field 4711 indicates an ID for identifying the reader/writer 1000 that has transmitted an interrogation signal 1410 received by the tag 4000. To be specific, such an ID is an ID set as the reader/writer ID 1412 of the interrogation signal 1410.

The power level field 4712 indicates a power level contained in the interrogation signal 1410.

[Operation]

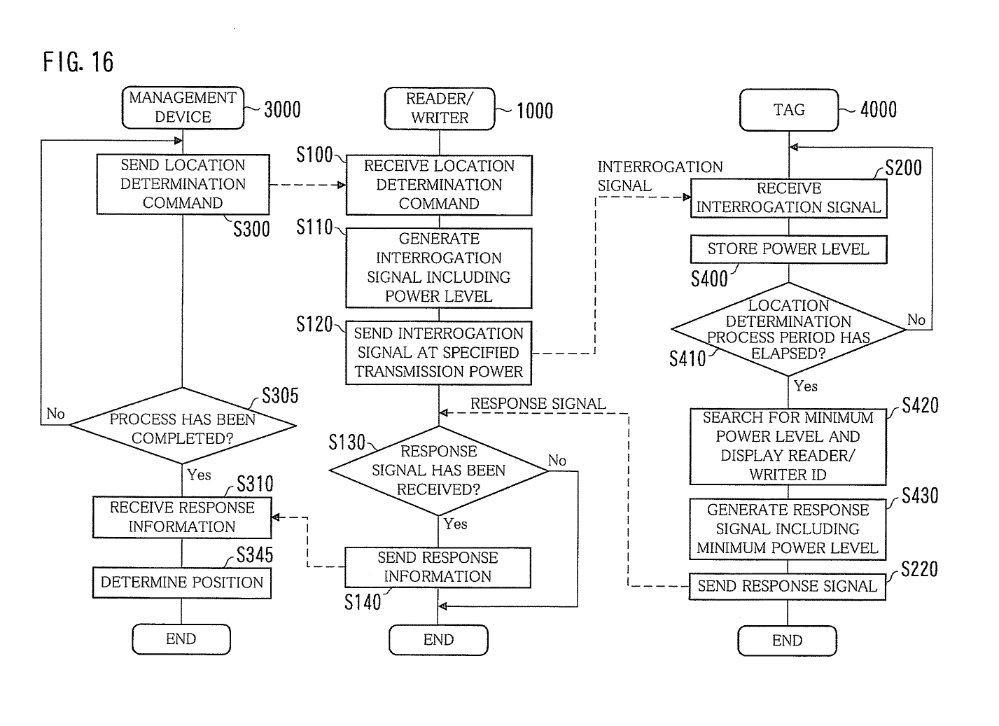

The following is a description of operation performed in the location determination system 100 of the second embodiment, with reference to FIG. 16.

FIG. 16 is a flowchart illustrating an example of the flow of a location determination process for locating the tag 4000 performed by the reader/writer 1000, the tag 4000, and the management device 3000.

The below description focuses on the points that differ from the location determination process according to the first embodiment. The points differing therefrom are a process performed by the tag 4000, and a position location process performed by the management device 3000.

Upon receiving a command, given by a user, to start a location determination process for locating the tag 4000, the control portion 3100 of the management device 3000 instructs the position detection portion 3300 to detect the position of the tag 4000.

Responding to the receipt of the instruction from the control portion 3100, the position detection portion 3300 transmits a command (location determination command) to determine the location of the tag 4000 to each of the reader/writers via the communication portion 3200 (Step S300) in such a manner to avoid the overlap of the transmission and reception periods 1401 (see FIG. 7) of the reader/writers.

In the transmission of the location determination command, the position detection portion 3300 reads out, from the transmission order table 3420 (see FIG. 4) stored in the communication information storage portion 3400, a power level specified in the power level field 3422 of a record having the value “1” in the order field 3421, and transmits the power level read out to the individual reader/writers via the communication portion 3200.

At a time when the position detection portion 3300 first gives the location determination command to the reader/writer, the position detection portion 3300 starts time measurement. After the given amount of time 3301 (see FIG. 7) has elapsed, the position detection portion 3300 reads out first, from the transmission order table 3420, a power level specified in the power level field 3422 of a record having the value “2” in the order field 3421, transmits the power level read out to each of the reader/writers, and transmits the location determination command thereto (Step S300).

Every time when the given amount of time 3301 has elapsed, the control portion 3100 repeats a process of transmitting the location determination command until the last record of the transmission order table 3420 is subjected to the process (Step S305).

After receiving the location determination command and the power level, the reader/writer 1000 performs the process of Step S100 through Step S120. That is to say, the reader/writer 1000 transmits an interrogation signal 1410 containing the power level therein. The process of Step S100 through Step S120 is the same as that discussed earlier with reference to FIG. 11.

The interrogation signal receiving portion 4200 of the tag 4000 receives the interrogation signal 1410 via the antenna 40 (Step S200). The interrogation signal receiving portion 4200, then, analyzes the interrogation signal 1410 received and conveys, to the control portion 4100, information indicating that the interrogation signal 1410 contains a location determination command, the reader/writer ID set as the reader/writer ID 1412 of the interrogation signal 1410, and the power level set as the power level 1413 thereof.

The control portion 4100 that has received the information starts measuring a location determination process period that is a period of time required for completing the location determination process. The control portion 4100 also clears the records of the interrogation signal management table 4710 stored in the received signal information storage portion 4700.

Subsequently, the control portion 4100 registers, into the interrogation signal management table 4710, the reader/writer ID and the power level received from the interrogation signal receiving portion 4200. To be specific, the control portion 4100 registers the reader/writer ID and the power level respectively in the reader/writer ID field 4711 and the power level field 4712 of the interrogation signal management table 4710 (Step S400).

Then, the control portion 4100 determines whether or not the location determination process period has elapsed. If determining that the location determination process period has not yet elapsed (Step S410: NO), then the control portion 4100 waits for an interrogation signal 1410 to be received, and performs the process of Step S400 through Step S410.

The location determination process period is specifically obtained by multiplying the given amount of time 3301 (see FIG. 7) and the number of records of the transmission order table 3420 (see FIG. 4). It is assumed that the location determination process period is stored in advance in an internal memory of the control portion 4100.

If determining that the location determination process period has already elapsed (Step S410: YES), then the control portion 4100 requests the minimum power level obtaining portion 4500 to determine the lowest power level and transmit a response signal 2310 containing the power level therein

Responding to the receipt of the request from the control portion 4100, the minimum power level obtaining portion 4500 searches, in the power level field 4712 of the interrogation signal management table 4710, for a record having the lowest value.

Subsequently, the minimum power level obtaining portion 4500 conveys, to the response signal generation portion 4400, a reader/writer ID set in the reader/writer ID field 4711 and a power level set in the power level field 4712 of the record found by the search, and requests the response signal generation portion 4400 to generate a response signal 2310.

The minimum power level obtaining portion 4500 further conveys, to the display portion 4600, the reader/writer ID set in the reader/writer ID field 4711 of the record found by the search, and requests the display portion 4600 to display the reader/writer ID. Upon receiving the request, the display portion 4600 displays the reader/writer ID on the liquid crystal display (Step S420).

The response signal generation portion 4400, which has been requested to generate a response signal 2310 and transmit the same, generates a response signal 2310 (see FIG. 6) (Step S430).

To be specific, the response signal generation portion 4400 sets the reader/writer ID received from the minimum power level obtaining portion 4500 as the reader/writer ID 2311 of the response signal 2310. The response signal generation portion 4400 also sets the ID of the subject tag 4000 as the tag ID 2312 of the response signal 2310, and sets the power level received from the minimum power level obtaining portion 4500 as the power level 2313 thereof.

After that, the response signal generation portion 4400 conveys the response signal 2310 generated to the response signal transmission portion 4300, and requests the same to transmit the response signal 2310.

Upon receiving the request, the response signal transmission portion 4300 transmits the response signal 2310, via the antenna 40, to the reader/writer 1000 (Step S220).

Upon receiving the response signal 2310, the reader/writer 1000 transmits, to the management device 3000, the tag ID set as the tag ID 2312 of the response signal 2310 received, the power level set as the power level 2313 thereof, and the subject device ID for identifying the subject reader/writer (Step S130 and Step S140). The process of Step S130 and Step S140 is the same as that discussed earlier with reference to FIG. 11.

Upon receiving the tag ID, the power level, and the subject device ID from the reader/writer 1000 (Step S310), the communication portion 3200 of the management device 3000 conveys the tag ID, the power level, and the subject device ID to the position detection portion 3300.

The position detection portion 3300 determines that the reader/writer identified by the reader/writer ID set as the reader/writer ID 2311 of the received response signal 2310 is a reader/writer closest to the tag 4000 identified by the tag ID set as the tag ID 2312 of the received response signal 2310.

The position detection portion 3300 refers to the propagation distance table 3410 (see FIG. 3), and determines a distance between the reader/writer that has been determined to be closest to the tag 4000 and the tag 4000.

To be more specific, a record is found out which has the same reader/writer ID as that contained in the reader/writer ID 2311 of the response signal 2310, and at the same time, has the same power level as that specified in the power level 2313 of the response signal 2310. The position detection portion 3300 then reads out a value specified in the propagation distance field 3413 of the record thus found out. The value that has been read out is determined to be the distance between the reader/writer and the tag 4000 identified by the tag ID contained in the response signal 2310.

Although the embodiments of the present invention have been described above, the present invention is not limited thereto. The following arrangement is possible.

1) In the embodiments described above, the location determination system using an active tag is described. Instead, however, a passive tag may be used in the location determination system.

Further, a target to be located by the location determination system is not limited to a tag. The target may be a mobile phone containing an IC card therein.

2) In the second embodiment, the liquid crystal display provided in the tag 4000 is configured to display an ID of a reader/writer closest to the tag 4000. Such a liquid crystal display may be configured to display other information, e.g., positional information of such a reader/writer.

In such a case, for example, a memory of the tag 4000 is caused to store the propagation distance table 3410 (see FIG. 3) therein. The minimum power level obtaining portion 4500 determines a propagation distance based on a specified lowest power level and a reader/writer ID, and requests the display portion 4600 to display the propagation distance. In this way, a user carrying the tag 4000 is capable of finding the distance between the tag 4000 and a reader/writer closest thereto.

3) According to the embodiments discussed above, a power level is incorporated into an interrogation signal, and then the interrogation signal is transmitted. Instead, a propagation distance corresponding to a power level (see the propagation distance table 3410) is incorporated into an interrogation signal, and then the interrogation signal may be transmitted.

4) The whole or a part of the individual elements of the location determination system illustrated in, for example, FIG. 2 may be realized in the form of a one-chip integrated circuit or multi-tip integrated circuits.

5) The whole or a part of the individual elements in the location determination system illustrated in, for example, FIG. 2 may be realized by a computer program, or may be implemented in any other formats.

In the case of a computer program, a computer is preferably caused to load the computer program written onto a recording medium such as a memory card or a CD-ROM, and to execute the computer program. Alternatively, a computer is preferably caused to download a computer program via a network and to execute the computer program.

The location determination system as configured above enables detection of the distance between a reader/writer and a tag in a simple manner.

The following examples are included in the embodiments discussed above.

### Example 1

A location determination system comprising:

a plurality of reader devices;

a management device; and

a tag,

wherein

each of the plurality of reader devices includes
an interrogation signal transmission portion that gradually changes a transmission power and sends an interrogation signal containing therein information on a power level indicating the transmission power, and
a transmission portion that receives a response signal, and sends, to the management device, information on a power level contained in the response signal and identification information for identifying the subject reader device,

the tag includes a response signal transmission portion that receives the interrogation signal and sends a response signal into which the information on the power level contained in the interrogation signal thus received is incorporated, and

the management device includes a position detection portion that receives, from said each of the plurality of reader devices, the information on the power level contained in the response signal and the identification information for identifying the subject reader device, and detects a position of the tag based on the information on the power level and the identification information thus received.

### Example 2

A location determination system comprising:

a plurality of reader devices; and

a management device,

wherein

each of the plurality of reader devices includes
an interrogation signal transmission portion that gradually changes a transmission power and sends an interrogation signal containing therein information on a power level indicating the transmission power, and
a transmission portion that receives, from a tag, a response signal corresponding to the interrogation signal sent by the interrogation signal transmission portion, and sends, to the management device, information on a power level contained in the response signal and identification information for identifying the subject reader device, and

the management device includes a position detection portion that receives, from said each of the plurality of reader devices, the information on the power level contained in the response signal and the identification information for identifying the subject reader device, and detects a position of the tag based on the information on the power level and the identification information thus received.

### Example 3

A location determination device for locating a tag in cooperation with a plurality of reader devices, the location determination device comprising:

an interrogation signal transmission control portion that causes each of the plurality of reader devices to gradually change a transmission power and to send an interrogation signal containing therein information on a power level indicating the transmission power;

a receiving portion that receives, from said each of the plurality of reader devices, information on a power level contained in a response signal and identification information for identifying the subject reader device, the response signal being sent by the tag in response to the interrogation signal sent by said each of the plurality of reader devices and being received by said each of the plurality of reader devices; and

a position detection portion that detects a position of the tag based on the information on the power level and the identification information received by the receiving portion.

### Example 4

The location determination device according to example 3, wherein the interrogation signal transmission control portion causes said each of the plurality of reader devices to gradually reduce the transmission power and to send the interrogation signal containing therein the information on the power level indicating the transmission power.

### Example 5

The location determination device according to example 3, wherein the interrogation signal transmission control portion causes said each of the plurality of reader devices to gradually increase the transmission power and to send the interrogation signal containing therein the information on the power level indicating the transmission power.

### Example 6

The location determination device according to example 3, further comprising a storage portion that stores the power level in association with a propagation distance of the interrogation signal when the interrogation signal is sent at the transmission power indicated in the power level,

wherein the position detection portion detects, as the position of the tag, a position falling within the propagation distance from the subject reader device identified by the identification information received by the receiving portion, the propagation distance being stored in association with the power level.

### Example 7

The location determination device according to example 3, wherein the response signal contains therein information on a minimum power level of the power level contained in the interrogation signal.

### Example 8

A location determination method used in a location determination system including a plurality of reader devices, a management device, and a tag, the location determination method comprising:

causing each of the plurality of reader devices to gradually change a transmission power and send an interrogation signal containing therein information on a power level indicating the transmission power;

causing the tag to receive the interrogation signal and send a response signal into which the information on the power level contained in the interrogation signal thus received is incorporated;

causing said each of the plurality of reader devices to receive the response signal, and send, to the management device, the information on the power level contained in the response signal and identification information for identifying the subject reader device; and

causing the management device to receive, from said each of the plurality of reader devices, the information on the power level contained in the response signal and the identification information for identifying the subject reader device, and detect a position of the tag based on the information on the power level and the identification information thus received.

### Example 9

A computer-readable storage medium storing thereon a computer program used in a location determination device for locating a tag in cooperation with a plurality of reader devices, the computer program causing the location determination device to execute processing for detecting a position of the tag, the processing comprising:

a process of sending, to each of the plurality of reader devices, a command to gradually change a transmission power and send an interrogation signal containing therein information on a power level indicating the transmission power;

a receiving process of receiving, from said each of the plurality of reader devices, information on a power level contained in a response signal and identification information for identifying the subject reader device, the response signal being sent by the tag in response to the interrogation signal sent by said each of the plurality of reader devices and being received by said each of the plurality of reader devices; and

a position detection process of detecting the position of the tag based on the information on the power level contained in the response signal and the identification information that are received in the receiving process.

### Example 10

A reader device for performing wireless communication with a wireless tag based on a command from a controller, the reader device comprising:

a determination portion that determines a transmission power at which a transmission signal is sent to the wireless tag;

an addition portion that incorporates information indicating a level of the transmission power thus determined into the transmission signal to be sent to the wireless tag;

a transmission portion that sends the transmission signal into which the level of the transmission power is incorporated at the transmission power;

a receiving portion that receives, in response to the transmission signal thus sent, a response signal containing therein tag identification information for identifying the wireless tag and information indicating the level of the transmission power incorporated into the transmission signal; and

a report portion that associates the tag identification information contained in the response signal with the information indicating the level of the transmission power contained in the response signal, and sends, to the controller, the tag identification information and the information indicating the level of the transmission power.

### Example 11

The reader device according to example 10, wherein

the addition portion further incorporates, into the transmission signal, reader identification information for identifying the reader device,

the receiving portion receives the response signal that further contains therein the reader identification information thus incorporated in addition to the tag identification information contained in the response signal and the information indicating the level of the transmission power contained in the response signal, and

the report portion associates the tag identification information contained in the response signal, the information indicating the level of the transmission power contained in the response signal, and the reader identification information contained in the response signal with one another, and sends, to the controller, the tag identification information, the information indicating the level of the transmission power, and the reader identification information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A location determination system comprising:
a plurality of reader devices;
a management device; and
a tag,
wherein
each of the plurality of reader devices includes
an interrogation signal transmission portion that gradually changes a transmission power and sends an interrogation signal containing therein information on a power level indicating the transmission power, and
a transmission portion that receives a response signal, and sends, to the management device, information on a power level contained in the response signal and identification information for identifying the subject reader device,
the tag includes a response signal transmission portion that receives the interrogation signal and sends a response signal into which the information on the power level contained in the interrogation signal thus received is incorporated, and
the management device includes a position detection portion that receives, from said each of the plurality of reader devices, the information on the power level contained in the response signal and the identification information for identifying the subject reader device, and detects a position of the tag based on the information on the power level and the identification information thus received.

2. A location determination device for locating a tag in cooperation with a plurality of reader devices, the location determination device comprising:
an interrogation signal transmission control portion that causes each of the plurality of reader devices to gradually change a transmission power and to send an interrogation signal containing therein information on a power level indicating the transmission power;
a receiving portion that receives, from said each of the plurality of reader devices, information on a power level contained in a response signal and identification information for identifying the subject reader device, the response signal being sent by the tag in response to the interrogation signal sent by said each of the plurality of reader devices and being received by said each of the plurality of reader devices; and
a position detection portion that detects a position of the tag based on the information on the power level and the identification information received by the receiving portion.

3. The location determination device according to claim 2, wherein the interrogation signal transmission control portion causes said each of the plurality of reader devices to gradually reduce the transmission power and to send the interrogation signal containing therein the information on the power level indicating the transmission power.

4. The location determination device according to claim 2, wherein the interrogation signal transmission control portion causes said each of the plurality of reader devices to gradually increase the transmission power and to send the interrogation signal containing therein the information on the power level indicating the transmission power.

5. The location determination device according to claim 2, further comprising a storage portion that stores the power level in association with a propagation distance of the interrogation signal when the interrogation signal is sent at the transmission power indicated in the power level,
wherein the position detection portion detects, as the position of the tag, a position falling within the propagation distance from the subject reader device identified by the identification information received by the receiving portion, the propagation distance being stored in association with the power level.

6. The location determination device according to claim 2, wherein the response signal contains therein information on a minimum power level of the power level contained in the interrogation signal.

7. A computer-readable storage medium storing thereon a computer program used in a location determination device for locating a tag in cooperation with a plurality of reader devices, the computer program causing the location determination device to execute processing for detecting a position of the tag, the processing comprising:
a process of sending, to each of the plurality of reader devices, a command to gradually change a transmission power and send an interrogation signal containing therein information on a power level indicating the transmission power;
a receiving process of receiving, from said each of the plurality of reader devices, information on a power level contained in a response signal and identification information for identifying the subject reader device, the response signal being sent by the tag in response to the interrogation signal sent by said each of the plurality of reader devices and being received by said each of the plurality of reader devices; and
a position detection process of detecting the position of the tag based on the information on the power level contained in the response signal and the identification information that are received in the receiving process.
